(19) United States
(12) Patent Application Publication
(10) Pub. No.: US 2007/0240915 A1
(43) Pub. Date: Oct. 18, 2007

(54) Fan of booster motor car

(76) Inventor: Yoshioki Tomoyasu, Fujisawa-shi (JP)

Correspondence Address: Yoshioki Tomoyasu, 21-22, Mirokuji 3-chome, Fujisawa-shi, 251-0016, JP

(21) Appl. No.: 11/403,976

(22) Filed: Apr. 14, 2006

(51) Int. Cl. B60K 16/00

(52) U.S. Cl. 180/2.2

(57) ABSTRACT

The invention is directed to develop for the motor car with the stronger driving force and less exhausting gases by means of applying the fan enclosed with the duct with the brim extending outward at the outlet installed on the front position of the identical shaft of either motor or engine thereof taking advantage of the force of the against wind to assist the rotating operation of the shaft thereof

### FIELD OF THE INVENTION

The present invention is generally directed to developing for the strong power of the motor car which is required for much lower costs in manufacturing as well as in running with less exhausting gases.

### BACKGROUND OF THE INVENTION

The motor car is required for saving fuels as well as decreasing exhausting gases from the environment's point of view. Thus, the motor car depend on augmenting driving force by means of developing for the technology for higher performance in driving operation with less consumption for fuels.

### DESCRIPTION OF THE PRIOR ART

The conventional motor car is liable to only depend on the development for the fuels yielded from the natural resources in driving operation, thus causing for heavy pollution in the global environment.

### SUMMARY OF THE INVENTION

The invention is generally directed to develop for the technology of taking advantage of the natural phenomena such as the against wind power which is possible to assist driving operation, thus preventing from causing air pollution and consuming the natural resources further in driving operation. The invention depend on the achievement by means of installing a fan enclosed with the duct to be rotated by the wind power in the front position on the identical shaft of either the motor or the engine of the motor car, whereby the driving force is assisted by the wind force as well as the attractive force caused by the pressure difference produced with the air stream flowing through the inside of the duct around the outlet.

### BRIEF DESCRIPTION OF THE DRAWINGS

FIG. 1: The layout of the electric circuit and dialogue of a hybrid motor car with the fan installed in the front of an identical shaft of the motor thereof as an example.

FIG. 2: Enlarged portion of the fan and in the neighbor of the electric circuit in the illustration of the mechanism as mentioned above as an example.

### DETAILED DESCRIPTION OF THE INVENTION

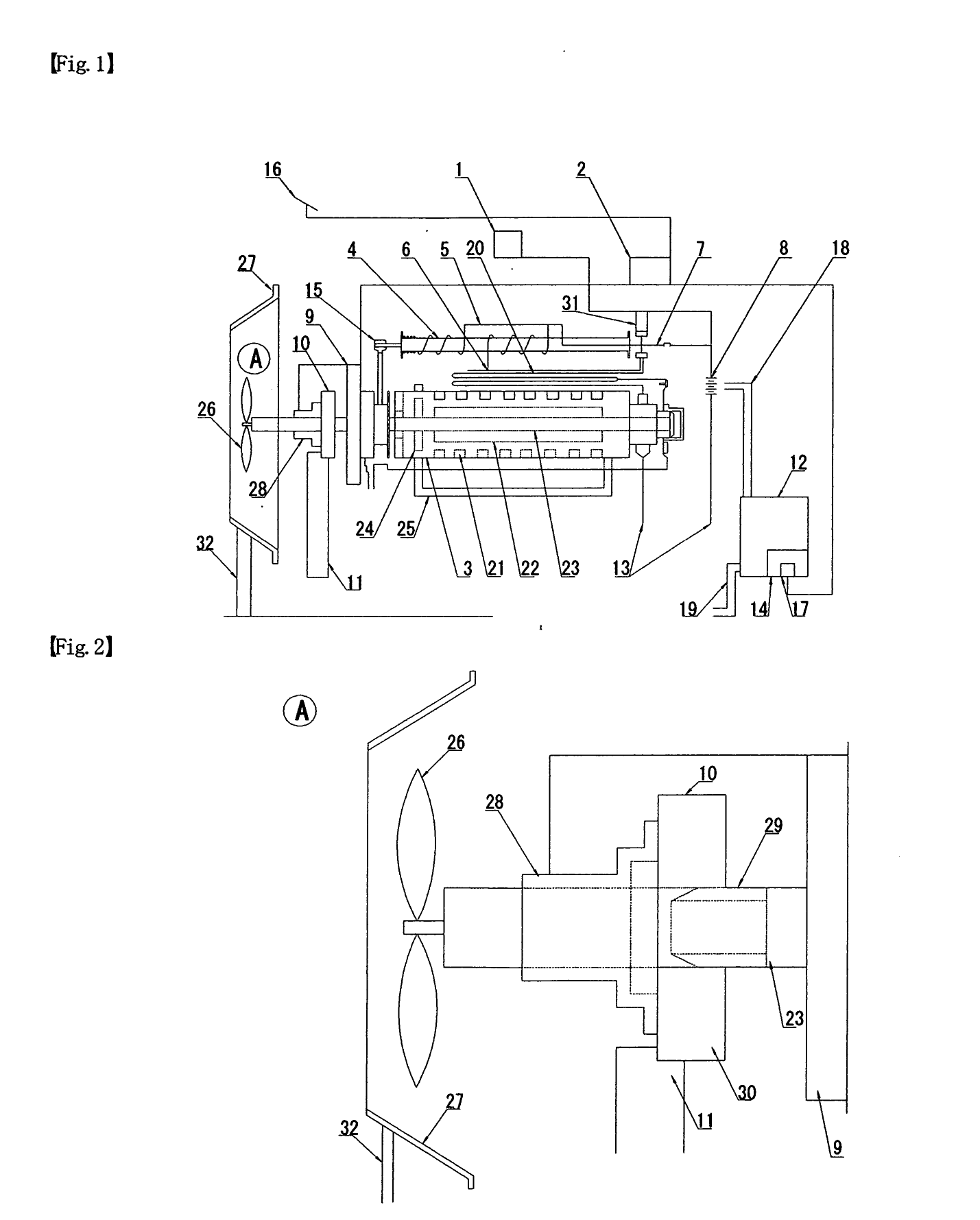

As shown FIG. 1, the present invention is directed to developing for the motor car of high power driving force by means of installing a fan(26) to be operated by the against wind in addition to the rotating force caused by either engine or motor(3). The above mentioned fan (26) with the duct (27) with brim extended outward at the outlet is installed in the front position of the identical shaft (23) of the motor(3) to assist the rotation of the fan(26) by attraction produced by the pressure difference being prevented from compensating for the air gap to be intruded by the air stream flowing along the outside wall of the damper(27) with the back of the brim acting as stopper, subsequently to saving energy in driving motor car. With a view to illustrating the performance of the above mentioned fan(26) enclosed with the duct(27) applied to the front position of the identical shaft(23) of the motor(3) of the above mentioned hybrid motor car converted from the starter motor(3)to the motor(3) capable of continuously driving on the operation of the ignition key(1) by means of actuating the magnet switch(28) to keep the pinion gear(10) in the engagement with the ring gear of the flywheel(11) generating with the crankshaft under the condition that the combustion in the engine appear to be absence because of being off the switch(17) of the motor(14) of the fuel tank(12) as well as the switch(7) of the battery(8) under the control of the computer(2) generating with the accelerating pedal (16) to transmit the signal for processing the function of switch over to the operation on the combustion and of actuating the magnet switch(28) to remove the pinion gear(10) in the engagement with the ring gear of the flywheel (11) to start for the regular operation of the engine at the time when the driving force is increased beyond the critical value, while the fan(26) is designed to keep generating the rotating operation of the shaft of the motor(3) where the magnet line of force caused between the rotor(22) fixed on the shaft(23) and the stator(21) is designed to generate the electric power in rotating operation of the shaft(23) generated with the operation of the fan(26) operated by the wind force in the driving operation of the motor car. Furthermore, the inside of the motor(3) is filled with the fluid to be circulated through the pipe(25) by dint of the vane(24) around the housing of the motor(3) to cool the temperature in generating the electric power which is to be charged for the battery(8) at high efficiency and the repeated switching operation possible according to the value.

1. The invention is related to the system capable of decreasing CO₂ gas exhausted from the piston-driven engine of the vehicle by means of installing the fan of which blades are operated with the force converted by the head wind in the running operation to cause for producing the additional driving force in the front position of the rotating shaft connected with the rotating operation of the crankshaft of said engine, whereby reducing the fuel consumption in driving operation of said vehicle.
